(19) United States
(12) Patent Application Publication
(10) Pub. No.: US 2026/0217257 A1
(43) Pub. Date: Jul. 30, 2026

(54) METHOD TO CONTROL A TRANSMISSION UNIT

(71) Applicant: Scania CV AB, Södertälje (SE)

(72) Inventors: Anders Björkman, Mariefred (SE); Mikael Öun, Nacka (SE); Martin Uppman, Älvsjö (SE)

(73) Assignee: Scania CV AB, Södertälje (SE)

(21) Appl. No.: 19/461,873

(22) Filed: Jan. 28, 2026

(30) Foreign Application Priority Data
Jan. 30, 2025 (SE) 2550087-7

(51) Int. Cl. B60W 30/192; B60W 10/02; B60W 10/10; B60W 30/182

(52) U.S. Cl. CPC B60W 30/192; B60W 10/02; B60W 10/10; B60W 30/182; B60W 2300/14; B60W 2300/17; B60W 2530/16; B60W 2530/207; B60W 2552/15; B60W 2710/021; B60W 2720/106

(57) ABSTRACT

The disclosure relates to a method performed by a control arrangement for controlling a drivetrain of a vehicle: obtaining sensor data, wherein the sensor data is at least indicative of vehicle characteristics and road characteristics of the vehicle, activating a paver mode of the drivetrain, if it is detected that the vehicle is moving in a longitudinal direction and is coupled to and being moved by a second vehicle.

### TECHNICAL FIELD

The present invention relates to control of transmission units.

### BACKGROUND

Drivetrains for heavy duty vehicles, e.g., trucks, are commonly designed with gearboxes connecting the power source to the drive wheels.

Typical requirements on gearboxes state that the user of the vehicle must activate the brake, e.g., press the brake pedal, before a gear may be engaged.

In scenarios when a truck is involved in paving actions, e.g., laying asphalt on a road surface, pressing the brake pedal creates an uneven or jerky motion that may affect the quality of the paving action.

During the paving action, the truck is typically operating with the gearbox in neutral, and is pushed forward by a paving vehicle. When the truck has finished unloading, a gear must be engaged so that the truck may move away from the paving vehicle.

Some conventional solutions design a dedicated button at the drivers position, that activates a paving mode. However, this requires additional hardware and increases the probability of user error.

Thus, there is a need for an improved method to control a transmission unit.

### OBJECTS OF THE INVENTION

An objective of embodiments of the present invention is to provide a solution which mitigates or solves the drawbacks described above.

### SUMMARY OF THE INVENTION

The above and further objectives are achieved by the subject matter described herein. Further advantageous implementation forms of the invention are described herein. The invention is set out in the appended claims. The scope of the invention is defined by the claims, which are incorporated into this section by reference.

According to a first aspect of the invention, the above-mentioned objective is achieved by a method performed by a control arrangement for controlling a drivetrain of a vehicle, the method comprising obtaining sensor data, wherein the sensor data is at least indicative of vehicle characteristics and road characteristics of the vehicle, activating a paver mode of the drivetrain, if it is detected that the vehicle is moving in a longitudinal direction and is coupled to and being moved by a second vehicle.

The advantages of the first aspect of the invention is at least that an improved accuracy of detection of paver action can be made. Further a reduced complexity of the vehicle is achieved, as no dedicated input devices, such as buttons on the dashboard, have to be added to the vehicle.

In one embodiment according to the first aspect, the detection is performed by evaluating a predetermined relation based on Newton's second law of motion using the sensor data.

This has the advantage that the method can be applied to any vehicle.

In one embodiment according to the first aspect, the predetermined relation is defined as:

$$\vert {M}_{Inc} + {M}_{roll} + \text{?} \vert > T$$

$$\text{?} \text{indicates text missing or illegible when filed}$$

where M_{Inc} is a first measure proportional to a road inclination force F_{Inc} acting on the vehicle, M_{Roll} is a second measure proportional to a roll resistance force F_{Roll} acting on the vehicle, a is measured acceleration in a longitudinal direction of the vehicle and T is a detection threshold value, wherein evaluating the predetermined relation comprises detecting that the vehicle is coupled to and being moved by a second vehicle if the predetermined relation is evaluated to be true, or detecting that the vehicle is not coupled to and being moved by a second vehicle if the predetermined relation is evaluated to be false.

This has the advantage that reduced computational complexity and reduced computational resource allocation is achieved.

In one embodiment according to the first aspect, the first measure M_{Inc} is estimated using the relation: M_{Inc}=g*sin (α), where α is estimated inclination of the road on which the vehicle is moving and g is gravitational acceleration.

In one embodiment according to the first aspect, the second measure M_{Roll} is estimated using the relation: M_{Roll}=g*C_{Roll}, where C_{Roll} is an estimated roll resistance factor.

In one embodiment according to the first aspect, the drivetrain operating in the paver mode comprises enabling engagement of a gear of the drivetrain when vehicle is in motion without requiring engagement of brakes.

According to a second aspect of the invention, the above-mentioned objective is achieved by a control arrangement configured to control a transmission unit to a target gear ratio, the control arrangement configured to perform the method according to the first aspect.

According to a third aspect of the invention, the above-mentioned objective is achieved by a computer program comprising instructions which, when the program is executed by a computer, cause the computer to carry out the method according to the first aspect.

According to a fourth aspect of the invention, the above-mentioned objective is achieved by a computer-readable medium comprising instructions which, when executed by a computer, cause the computer to carry out the method according to the first aspect.

The advantages of the second to fourth aspects are at least the same as for the first aspect.

Reference will be made to the appended sheets of drawings that will first be described briefly. It should be appreciated that, like reference numerals are used to identify like elements illustrated in one or more of the drawings.

### BRIEF DESCRIPTION OF THE DRAWINGS

FIG. 1 schematically illustrates a vehicle according to one or more embodiments of the invention.

FIG. 2 schematically illustrates forces acting on the vehicle.

FIG. 3A-B illustrates different scenarios involving the vehicle.

FIG. 4A-B illustrates a scenario where it is or is not detected that the vehicle is coupled to and being moved by a second vehicle.

FIG. 5 shows a computer according to one or more embodiments of the present disclosure.

FIG. 6 shows a flowchart of a method according to one or more embodiments of the present disclosure.

FIG. 7 illustrates an example of the predetermined relation according to one or more embodiments of the present disclosure.

A more complete understanding of embodiments of the invention will be afforded to those skilled in the art, as well as a realization of additional advantages thereof, by a consideration of the following detailed description of one or more embodiments.

### DETAILED DESCRIPTION

An “or” in this description and the corresponding claims is to be understood as a mathematical OR which covers “and” and “or”, and is not to be understand as an XOR (exclusive OR). The indefinite article “a” in this disclosure and claims is not limited to “one” and can also be understood as “one or more”, i.e., plural.

In the present disclosure, the term “computer” and/or “control arrangement” and/or “device” and/or “system” denotes a unit comprising processor, and a memory, said memory containing instructions executable by said processor, wherein said unit is configured to perform any of the methods described herein. The control arrangement is typically capable of receiving input data that is comprised in control signals, and to control other units by sending commands comprised in control signals. In one example, the control arrangement is a general-purpose computer.

In the present disclosure, the term “longitudinal direction” denotes a direction substantially along a longitudinal line or curve substantially aligned with the elongated shape of a vehicle. In other words, an elongated vehicle will typically move forwards or backwards substantially along a longitudinal line or curve. In one example, the longitudinal direction may align with or be parallel to the line or align with a tangent of the curve.

In the present disclosure, the term “inclination of the road” denotes a measure of an inclination of the surface/road under the vehicle in the longitudinal direction. In other words, an angular measure of how much the surface/road leans or is angled related to a flat surface.

In the present disclosure, the term “paver mode” denotes an operational mode of a transmission unit that allows engagement of a gear when the vehicle is moving without activating a brake system, e.g., without having to push the brake pedal down before a gear may be engaged.

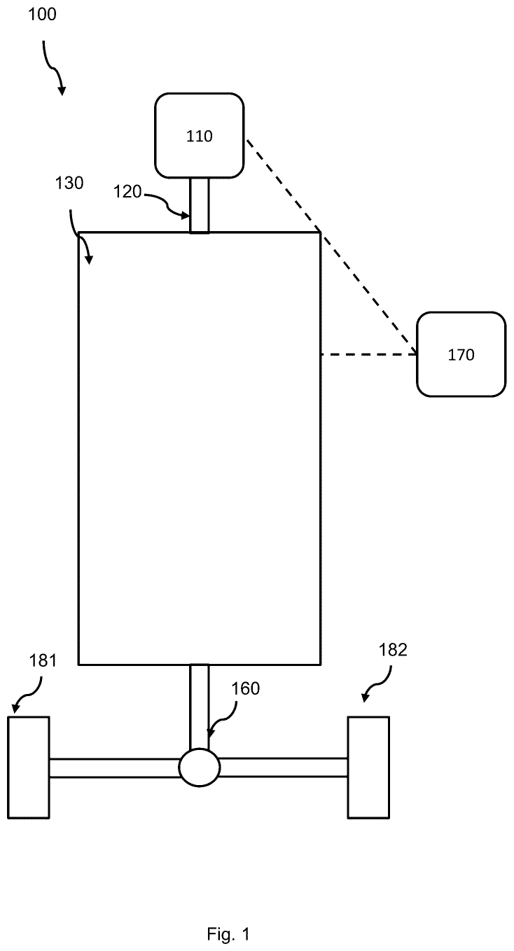

FIG. 1 schematically illustrates a vehicle 100 according to one or more embodiments of the invention. The vehicle 100 includes a powertrain comprising a power unit 110 or propulsion unit 110, such as an electric engine or combustion engine. The vehicle 100 may further optionally include a clutch unit (not shown) arranged between the propulsion unit 110 and the transmission unit 130.

The transmission unit 130 is coupled or connected to the propulsion unit 110 of the vehicle 100 via an input shaft 120 of the transmission unit 100. The transmission unit 130 is coupled or connected to the driving wheels 181, 182 of the vehicle 100 via an output shaft 160 of the transmission unit 100.

A control arrangement 170 is communicatively coupled to the propulsion unit 110 and/or the transmission unit 130. The control arrangement 170 is further configured to send control signals to control the propulsion unit 110 and/or the transmission unit 130. The control arrangement 170 is further configured to receive control signals from any unit or sensor of the vehicle 100 indictive of status of respective units or sensors, e.g., the propulsion unit 110 and/or the transmission unit 130.

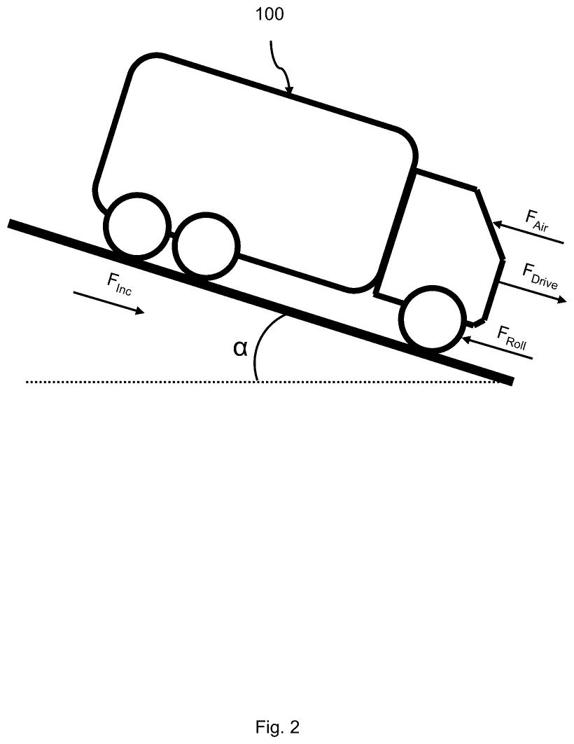

FIG. 2 schematically illustrates forces acting on the vehicle 100. FIG. 2 illustrates some typical forces acting on the vehicle 100 when it is moving.

A road inclination force F_{Inc} is acting on the vehicle depending on an inclination a of the road/surface in the longitudinal direction on which the vehicle is moving. On a flat surface, or a surface perpendicular to the gravitational force of Earth, the road inclination force F_{Inc} is zero.

A roll resistance force F_{Roll} acts on the vehicle, e.g., depending on tires used by the vehicle and also due to other losses. Such losses may include friction losses in the powertrain, e.g., friction in wheel bearings and gearbox.

An air resistance force F_{Air} is acting on the vehicle depending on a current velocity of the vehicle and a constant value related to the exterior design of the vehicle.

If a gear of the transmission unit 130 is engaged, a driving force F_{Drive} from the propulsion unit 110 is also typically acting on the vehicle.

When performing paving actions, the transmission unit 130 is typically placed in neutral and no driving force F_{Drive} is acting on the vehicle.

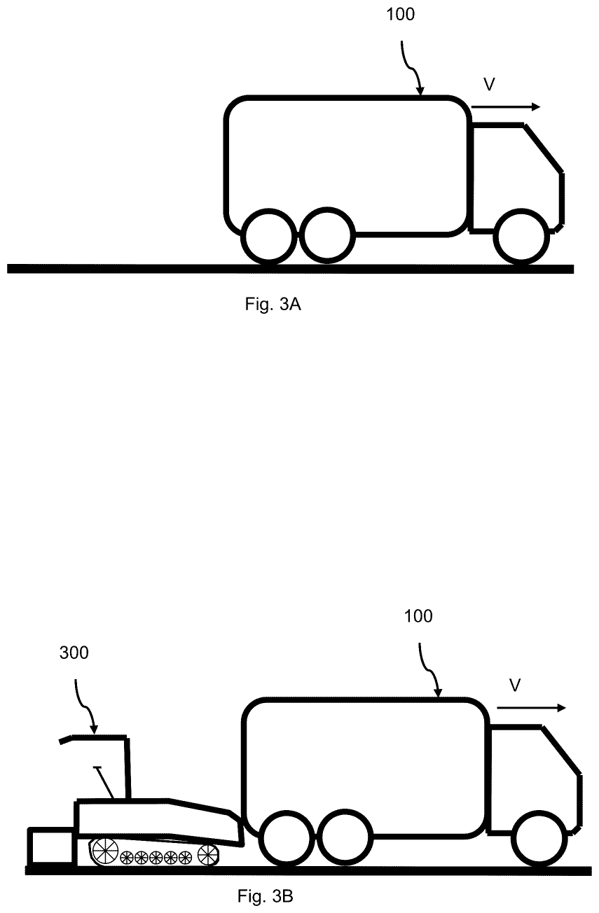

FIG. 3A illustrates a scenario where the vehicle 100 is not coupled to and being moved by a second vehicle 300.

In one example, the vehicle 100 may be moving at a velocity V in the longitudinal direction with the transmission unit 130 typically placed in neutral.

In FIG. 3A a flat surface is shown, but it is understood that the surface may equally have an inclination as shown in FIG. 2.

In this scenario, the paver mode should not be activated according to the present disclosure, as movement of the vehicle 100 comply with the predetermined relation, e.g., based on Newtons second law of motion.

FIG. 3B illustrates a scenario where the vehicle 100 is coupled to and being moved by the second vehicle 300 as movement of the vehicle 100 does not comply with the predetermined relation, e.g., based on Newtons second law of motion. In the scenario illustrated in FIG. 3B, the second vehicle 300 is a paver vehicle.

In one example, the vehicle 100 may be moving at a velocity V in the longitudinal direction with the transmission unit 130 typically placed in neutral.

In FIG. 3A a flat surface is shown, but it is understood that the surface may equally have an inclination as shown in FIG. 2.

In this scenario, the paver mode should be activated according to the present disclosure.

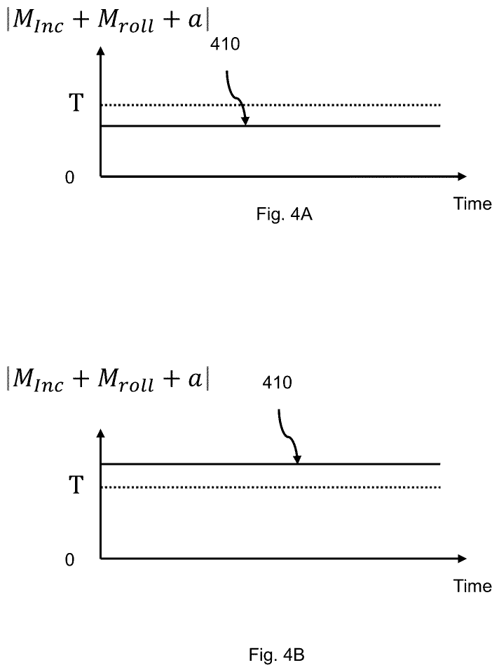

FIG. 4A illustrates a scenario where it is not detected that the vehicle is 100 coupled to and being moved by a second vehicle 300.

FIG. 4A shows a diagram with the term |M_{Inc}+Mᵣₒₗₗ+a| on the vertical axis and time on the horizontal axis. It is understood that the term |M_{Inc}+Mᵣₒₗₗ+a| is shown as having a constant value, but may typically vary over time, e.g., depending on road inclination profile and measurement quality.

M_{Inc} is a first measure proportional to the road inclination force F_{Inc} acting on the vehicle, M_{Roll} is a second measure proportional to the roll resistance force F_{Roll} acting on the vehicle, a is measured acceleration in a longitudinal direction of the vehicle and T is a detection threshold value.

The detection threshold value T is shown as the dotted line. The term |M_{Inc}+Mᵣₒₗₗ+a| varying over time is shown as a solid line.

As can be seen in FIG. 4A, the term |M_{Inc}+Mᵣₒₗₗ+a| remains under the threshold value T, and no detection that the vehicle is 100 coupled to and being moved by a second vehicle 300 is made. In other words, in this scenario paver mode is not activated or enabled.

FIG. 4B illustrates a scenario where the it is detected that the vehicle is 100 coupled to and being moved by a second vehicle 300.

FIG. 4B shows a diagram with the term |M_{Inc}+Mᵣₒₗₗ+a| on the vertical axis and time on the horizontal axis. It is understood that the term |M_{Inc}+Mᵣₒₗₗ+a| is shown as having a constant value, but may typically vary over time depending on road inclination profile and measurement quality.

M_{Inc} is a first measure proportional to the road inclination force F_{Inc} acting on the vehicle, M_{Roll} is a second measure proportional to the roll resistance force F_{Roll} acting on the vehicle, a is measured acceleration in a longitudinal direction of the vehicle and T is a detection threshold value.

The detection threshold value T is shown as the dotted line. The term |M_{Inc}+Mᵣₒₗₗ+a| varying over time is shown as a solid line.

As can be seen in FIG. 4B, the term |M_{Inc}+Mᵣₒₗₗ+a| exceeds the threshold value T, and detection that the vehicle is 100 coupled to and being moved by a second vehicle 300 is made. In other words, in this scenario paver mode is activated or enabled.

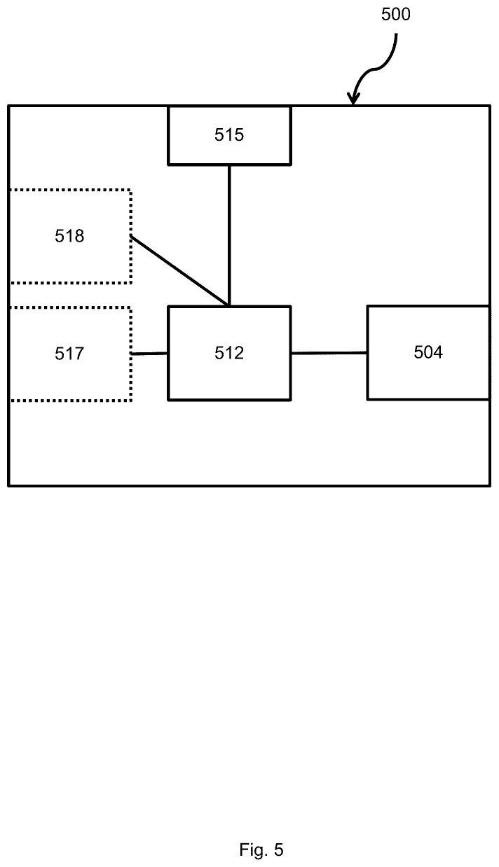

FIG. 5 shows a computer 500 according to one or more embodiments of the present disclosure. The computer may e.g., be in the form of an Electronic Control Unit, a server, an on-board computer, a control arrangement, a vehicle mounted computer system or a navigation device. The computer may comprise a processor or processing means 512 communicatively coupled to a transceiver 504 configured for wired or wireless communication. Further, the computer may further comprise at least one optional antenna (not shown in figure). The antenna may be coupled to the transceiver 504 and is configured to transmit and/or emit and/or receive wireless signals in a wireless communication system, e.g., wireless signals comprising diagnostic actions or diagnostic data.

In one example, the processor 512 may be any of a selection of processing circuitry and/or a central processing unit and/or processor modules and/or multiple processors configured to cooperate with each-other. Further, the computer may further comprise a memory 515. The memory 515 may contain instructions executable by the processor to perform any of the methods described herein. The memory and/or computer-readable storage medium referred to herein may comprise of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

In a further embodiment, the computer may further comprise and/or be coupled to one or more sensors (not shown) configured to e.g., receive and/or obtain and/or measure physical properties pertaining to the vehicle 100 and/or transmission unit 130 and/or propulsion unit 110 and/or the road on which the vehicle 100 is moving upon and send one or more sensor signals indicative of the physical properties to the processing means 512.

In one or more embodiments the computer may further comprise an input device 517, configured to receive input or indications from a user and send a user-input signal indicative of the user input or indications to the processor or processing means 512.

In one or more embodiments the computer may further comprise a display 518 configured to receive a display signal indicative of rendered objects, such as text or graphical user input objects, from the processor or processing means 512 and to display the received signal as objects, such as text or graphical user input objects.

In one embodiment the display 518 is integrated with the user input device 517 and is configured to receive a display signal indicative of rendered objects, such as text or graphical user input objects, from the processing means 512 and to display the received signal as objects, such as text or graphical user input objects, and/or configured to receive input or indications from a user and send a user-input signal indicative of the user input or indications to the processing means 512.

In embodiments, the processing means 512 is communicatively coupled to a selection of any of the memory 515 and/or the communications interface and/or transceiver and/or the input device 517 and/or the display 518 and/or the one or more sensors. In embodiments, the transceiver 504 communicates using wired and/or wireless communication techniques. The wired or wireless communication techniques may comprise any of a CAN bus, Bluetooth, Wi-Fi, GSM, UMTS, LTE or LTE advanced communications network or any other wired or wireless communication network known in the art.

The control arrangement, 170, described herein may comprise all, or a selection of the features described in relation to FIG. 5. In other words, the computer 500 may be comprised in the control arrangement 170.

In one embodiment, a control arrangement, CA, is provided, the CA comprising:
a processor, and a memory, said memory containing instructions executable by said processor, whereby said CA is operative to perform any of the methods described herein.

In one embodiment, a computer program (product) is provided and comprises instructions which, when the program is executed by a computer, cause the computer to carry out any of the methods described herein.

In one embodiment, a computer-readable medium is provided and comprises instructions which, when executed by a computer, cause the computer to carry out any of the methods described herein.

The term “computer” may be defined as any hardware or hardware/firmware device implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, an application-specific integrated circuit, or any other device capable of electronically performing operations in a defined manner.

In some embodiments, the computer-readable medium may be a non-transitory computer-readable medium, such as a tangible electronic, magnetic, optical, infrared, electromagnetic, and/or semiconductor system, apparatus, and/or device.

In one embodiment, the computer program product may be a computer readable medium, and the computer program may be stored in the computer readable medium described herein.

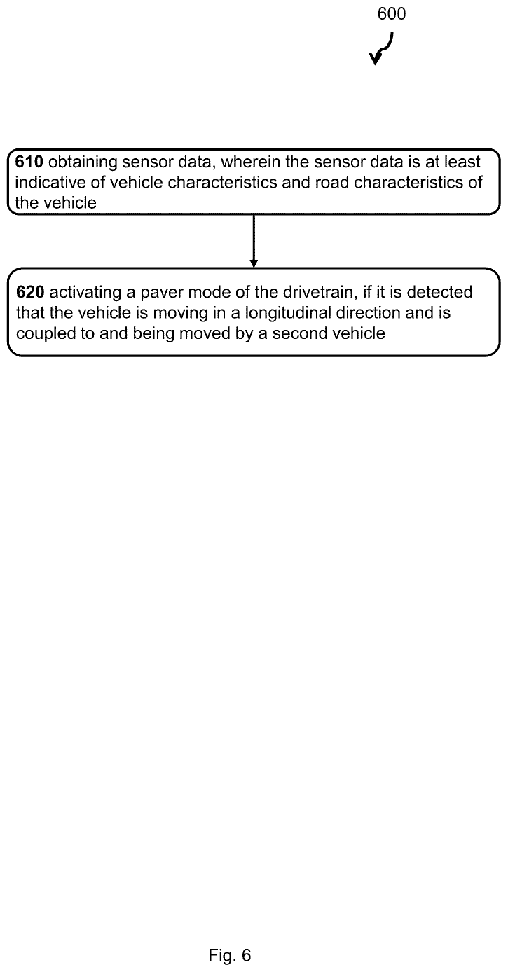

FIG. 6 shows a flowchart of a method 600 according to one or more embodiments of the present disclosure. The method is performed by the control arrangement 170 for controlling the drivetrain of the vehicle 100. The method 600 comprising:

Step 610: obtaining sensor data. In one embodiment, the sensor data is at least indicative of vehicle characteristics and road characteristics of the vehicle 100.

In one non limiting the vehicle characteristics comprises a selection of any of vehicle mass/weight m, driving force F_{Drive}, an estimated roll resistance factor C_{Roll}, an estimated air resistance factor C_{Air}, and a measured vehicle speed V.

The roll resistance factor C_{Roll}, is indicative of losses related to rotation of parts of the drivetrain, such as friction losses in the powertrain, e.g., friction in wheel bearings.

The estimated air resistance factor C_{Air} is indicative of air resistance acting on the vehicle depending on a current velocity of the vehicle, typically also strongly correlated to the exterior design of the vehicle.

Step 620: activating a paver mode of the drivetrain, if it is detected that the vehicle is moving in a longitudinal direction and is coupled to and being moved by a second vehicle 300.

In one embodiment, the detection is performed by evaluating a predetermined relation based on Newton's second law of motion using the sensor data.

Additionally, or alternatively, the predetermined relation is defined as:

$$\vert {M}_{Inc} + {M}_{roll} + \text{?} \vert > T$$

$$\text{?} \text{indicates text missing or illegible when filed}$$

where M_{Inc} is a first measure proportional to a road inclination force F_{Inc} acting on the vehicle, M_{Roll} is a second measure proportional to a roll resistance force F_{Roll} acting on the vehicle, a is measured acceleration in a longitudinal direction of the vehicle and T is a detection threshold value. Further, evaluating the predetermined relation comprises detecting that the vehicle is coupled to and being moved by a second vehicle if the predetermined relation is evaluated to be true, or detecting that the vehicle is not coupled to and being moved by a second vehicle if the predetermined relation is evaluated to be false.

Additionally, or alternatively, the first measure M_{Inc} is estimated using the relation:

M_{Inc}=g*sin (α), where α is estimated inclination of the road on which the vehicle is moving and g is gravitational acceleration. The estimated inclination of the road a may e.g., be based on measurements from an acceleration sensor and/or a gyro sensor.

Additionally, or alternatively, the second measure M_{Roll} is estimated using the relation:

M_{Roll}=g*C_{Roll}, where C_{Roll} is the estimated roll resistance factor.

Additionally, or alternatively, the drivetrain operating in the paver mode comprises enabling engagement of a gear of the drivetrain when vehicle is in motion without requiring engagement of brakes.

In embodiments, the communications network herein communicate using wired or wireless communication techniques that may include at least one of a Local Area Network (LAN), Metropolitan Area Network (MAN), Global System for Mobile Network (GSM), Enhanced Data GSM Environment (EDGE), Universal Mobile Telecommunications System, Long term evolution, High Speed Downlink Packet Access (HSDPA), Wideband Code Division Multiple Access (W-CDMA), Code Division Multiple Access (CDMA), Time Division Multiple Access (TDMA), Bluetooth®, Zigbee®, Wi-Fi, Voice over Internet Protocol (VoIP), LTE Advanced, IEEE802.16m, Wireless MAN-Advanced, Evolved High-Speed Packet Access (HSPA+), 3GPP Long Term Evolution (LTE), Mobile WiMAX (IEEE 802.16e), Ultra Mobile Broadband (UMB) (formerly Evolution-Data Optimized (EV-DO) Rev. C), Fast Low-latency Access with Seamless Handoff Orthogonal Frequency Division Multiplexing (Flash-OFDM), High Capacity Spatial Division Multiple Access (iBurst®) and Mobile Broadband Wireless Access (MBWA) (IEEE 802.20) systems, High Performance Radio Metropolitan Area Network (HIPERMAN), Beam-Division Multiple Access (BDMA), World Interoperability for Microwave Access (Wi-MAX) and ultrasonic communication, etc., but is not limited thereto.

Moreover, it is realized by the skilled person that the system and/or devices may comprise the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, encoder, decoder, power supply units, power feeders, communication interfaces, communication protocols, etc. which are suitably arranged together for performing the present solution.

Especially, the processor and/or processing means of the present disclosure may comprise one or more instances of processing circuitry, processor modules and multiple processors configured to cooperate with each-other, Central Processing Unit (CPU), a processing unit, a processing circuit, a processor, an Application Specific Integrated Circuit (ASIC), a microprocessor, a Field-Programmable Gate Array (FPGA) or other processing logic that may interpret and execute instructions. The expression “processor” and/or “processing means” may thus represent a processing circuitry comprising a plurality of processing circuits, such as, e.g., any, some or all of the ones mentioned above. The processing means may further perform data processing functions for inputting, outputting, and processing of data comprising data buffering and device control functions, such as call processing control, user interface control, or the like.

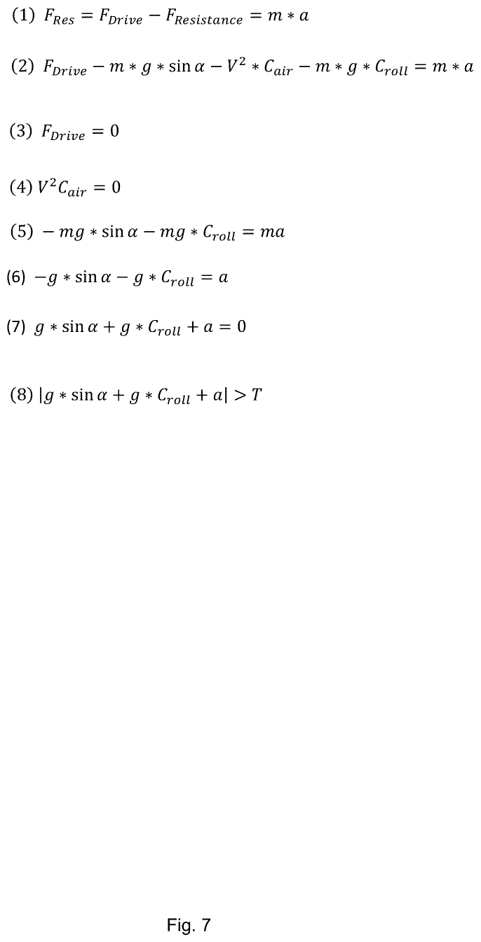

FIG. 7 illustrates an example of the predetermined relation according to one or more embodiments of the present disclosure.

The predetermined relation may be derived from Newton's second law of motion, illustrated by equation (1). The resulting force F_{Res} may be calculated as the driving force F_{Drive} acting on the vehicle 100 minus the resistance force F_{Resistance} acting on the vehicle 100. This equals mass of the vehicle m multiplied with acceleration a in the longitudinal direction.

By replacing the resistance force F_{Resistance} with the road inclination force F_{Inc}, the roll resistance force F_{Roll}, and the air resistance force F_{Air} equation (2) is obtained.

Further, by making the assumption that the transmission unit 130 is in neutral, the driving force F_{Drive} may be set=0, equation (3). When performing paving actions, the transmission unit 130 is typically placed in neutral and no driving force F Drive is acting on the vehicle.

Further, by making the assumption that the air resistance is negligible, the air resistance force F_{Air} may be set=0, equation (4). When performing paving actions, the speed V is typically relatively low resulting in negligible air resistance.

Equation (2) may then be written as equation (5).

Further, as the mass of the vehicle m is present on both sides of equation (5), m may be removed, and equation (5) may be rewritten as equation (6).

By moving all terms to one side, equation (6) may be rewritten as equation (7), where the result equals 0 if Newton's second law of motion applies, and no external forces are acting on the vehicle. In other words, the vehicle is not coupled to and being moved by a second vehicle.

To account for sensor precision, noise and interference, it is not practical to detect that the vehicle is coupled to and being moved by a second vehicle as soon as an absolute value of the term |M_{Inc}+Mᵣₒₗₗ+a| deviates from zero.

A detection threshold value T is therefore introduced to provide a hysteresis function or to reduce the rate of false detections. In one non-limiting example, the threshold value T is set to 10% of a typical driving force of a paving vehicle used.

The predetermined relation may then be derived, as shown in equation (8).

Finally, it should be understood that the invention is not limited to the embodiments described above, but also relates to and incorporates all embodiments within the scope of the appended independent claims.

1. A method performed by a control arrangement for controlling a drivetrain of a vehicle, the method comprising:
obtaining sensor data, wherein the sensor data is at least indicative of vehicle characteristics and road characteristics of the vehicle; and
activating a paver mode of the drivetrain, if it is detected that the vehicle is moving in a longitudinal direction and is coupled to and being moved by a second vehicle.

2. The method according to claim 1, wherein the detection is performed by evaluating a predetermined relation based on Newton's second law of motion using the sensor data.

3. The method according to claim 2, wherein the predetermined relation is defined as:
$$\vert {M}_{Inc} + {M}_{roll} + \text{?} \vert > T$$
$$\text{?} \text{indicates text missing or illegible when filed}$$
where;
M_{Inc} is a first measure proportional to a road inclination force F_{Inc} acting on the vehicle,
M_{Roll} is a second measure proportional to a roll resistance force F_{Roll} acting on the vehicle, and
a is measured acceleration in a longitudinal direction of the vehicle and T is a detection threshold value, and
wherein evaluating the predetermined relation comprises detecting that the vehicle is coupled to and being moved by a second vehicle if the predetermined relation is evaluated to be true, or detecting that the vehicle is not coupled to and being moved by a second vehicle if the predetermined relation is evaluated to be false.

4. The method according to claim 3, wherein the first measure M_{Inc} is estimated using the relation:
$${M}_{Inc} = g * sin ( α )$$
where α is estimated inclination of the road on which the vehicle is moving and g is gravitational acceleration.

5. The method according to claim 3, wherein the second measure M_{Roll} is estimated using the relation:
$${M}_{Roll} = g * {C}_{Roll}$$
where C_{Roll} is an estimated roll resistance factor.

6. The method according to claim 1, wherein the drivetrain operating in the paver mode comprises enabling engagement of a gear of the drivetrain when vehicle is in motion without requiring engagement of brakes.

7. A control arrangement configured to control a drivetrain of a vehicle, said control arrangement configured to perform the following operations:
obtaining sensor data, wherein the sensor data is at least indicative of vehicle characteristics and road characteristics of the vehicle; and
activating a paver mode of the drivetrain, if it is detected that the vehicle is moving in a longitudinal direction and is coupled to and being moved by a second vehicle.

8. (canceled)

9. (canceled)

10. The control arrangement according to claim 7, wherein the detection is performed by evaluating a predetermined relation based on Newton's second law of motion using the sensor data.

11. The control arrangement according to claim 7, wherein the predetermined relation is defined as:
$$\vert {M}_{Inc} + {M}_{roll} + \text{?} \vert > T$$
$$\text{?} \text{indicates text missing or illegible when filed}$$
where:
M_{Inc} is a first measure proportional to a road inclination force F_{Inc} acting on the vehicle,
M_{Roll} is a second measure proportional to a roll resistance force F_{Roll} acting on the vehicle, and
a is measured acceleration in a longitudinal direction of the vehicle and T is a detection threshold value, and
wherein evaluating the predetermined relation comprises detecting that the vehicle is coupled to and being moved by a second vehicle if the predetermined relation is evaluated to be true, or detecting that the vehicle is not coupled to and being moved by a second vehicle if the predetermined relation is evaluated to be false.

12. The control arrangement according to claim 11, wherein the first measure M_{Inc} is estimated using the relation:
$${M}_{Inc} = g * sin ( α )$$
where α is estimated inclination of the road on which the vehicle is moving and g is gravitational acceleration.

13. The control arrangement according to claim 11, wherein the second measure M_{Roll} is estimated using the relation:
$${M}_{Roll} = g * {C}_{Roll}$$
where C_{Roll} is an estimated roll resistance factor.

14. The control arrangement according to claim 7, wherein the drivetrain operating in the paver mode comprises enabling engagement of a gear of the drivetrain when vehicle is in motion without requiring engagement of brakes.

15. A computer program product for controlling a drivetrain of a vehicle, wherein said computer program product comprising computer instructions to cause one or more computing devices to perform the following operations:
obtaining sensor data, wherein the sensor data is at least indicative of vehicle characteristics and road characteristics of the vehicle; and
activating a paver mode of the drivetrain, if it is detected that the vehicle is moving in a longitudinal direction and is coupled to and being moved by a second vehicle.

16. The computer program product according to claim 15, wherein the detection is performed by evaluating a predetermined relation based on Newton's second law of motion using the sensor data.

17. The computer program product according to claim 16, wherein the predetermined relation is defined as:
$$\vert {M}_{Inc} + {M}_{roll} + \text{?} \vert > T$$
$$\text{?} \text{indicates text missing or illegible when filed}$$
where:
M_{Inc} is a first measure proportional to a road inclination force F_{Inc} acting on the vehicle,
M_{Roll} is a second measure proportional to a roll resistance force F_{Roll} acting on the vehicle, and
a is measured acceleration in a longitudinal direction of the vehicle and T is a detection threshold value, and
wherein evaluating the predetermined relation comprises detecting that the vehicle is coupled to and being moved by a second vehicle if the predetermined relation is evaluated to be true, or detecting that the vehicle is not coupled to and being moved by a second vehicle if the predetermined relation is evaluated to be false.

18. The computer program product according to claim 17, wherein the first measure M_{Inc} is estimated using the relation:
$${M}_{Inc} = g * sin ( α )$$
where α is estimated inclination of the road on which the vehicle is moving and g is gravitational acceleration.

19. The computer program product according to claim 17, wherein the second measure M_{Roll} is estimated using the relation:
$${M}_{Roll} = g * {C}_{Roll}$$
where C_{Roll} is an estimated roll resistance factor.

20. The computer program product according to claim 15, wherein the drivetrain operating in the paver mode comprises enabling engagement of a gear of the drivetrain when vehicle is in motion without requiring engagement of brakes.
